(19) United States
(12) Patent Application Publication
(10) Pub. No.: US 2003/0078002 A1
(43) Pub. Date: Apr. 24, 2003

(54) Method for wireless link reestablishment

(76) Inventors: Raghunandan Sanjeev, Grayslake, IL (US); Daniel S. Rokusek, Long Grove, IL (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/000,605

(22) Filed: Oct. 24, 2001

(51) Int. Cl. H04B 5/00

(52) U.S. Cl. 455/41; 455/517; 455/450

(57) ABSTRACT

A method of wireless link (316) reestablishment between a remote device (302, 402) and a client device (304, 404) in a wireless personal area network (102, 202) includes establishing a wireless link (316) between remote device (302, 402) and client device (304, 404) where client device (304, 404) maintains connection data (318). The wireless link (316) is subsequently terminated. Client device (304, 404) determines the type of termination by differentiating between a link loss termination and a non-link loss termination. If loss is due to a link loss termination, client device (304, 404) reestablishes the wireless link (316) to remote device (302, 402) utilizing connection data (318).

### BACKGROUND OF THE INVENTION

In a wireless communication system, a communications link between two devices can be inadvertently disrupted. This can be due to interference or a user moving out of range of another wireless device. Such disruptions can cause user inconvenience in the case of voice transmissions and potentially lost or corrupted data in data transmissions. Some cellular systems have automatic call back for voice transmissions where a base station or the wireless communication system itself initiates a reconnection scheme. These prior art methods are limited to voice systems and generally require user interaction at one or both ends of the communications link.

In a wireless personal area network, devices can also be disconnected due to interference or moving out of range. In addition, devices can be disconnected at the service level because of resource constraints and the like. In the prior art, a user would have to initiate a call back to the service providing entity and reestablish connectivity with the service providing entity, in effect initiating a new call. This is inconvenient for the user and can lead to incomplete or corrupted data transfers that have to be restarted. Any auto reconnect feature currently available requires that the service providing entity initiate or be involved in any auto reconnect sequence.

Accordingly, there is a significant need for a method for wireless link reestablishment in a wireless personal area network that overcomes the deficiencies of the prior art outlined above.

### BRIEF DESCRIPTION OF THE DRAWINGS

Referring to the drawing:

FIG. 1 depicts a communications system according to one embodiment of the invention;

FIG. 2 depicts a communications system according to another embodiment of the invention;

FIG. 3 illustrates a simplified block diagram according to an embodiment of the invention;

FIG. 4 illustrates a simplified block diagram according to an embodiment of the invention;

FIG. 5 illustrates a simplified Bluetooth protocol stack according to an embodiment of the invention;

FIG. 6 illustrates a simplified message sequence chart according to an embodiment of the invention; and

FIG. 7 illustrates a flow diagram of a method of the invention according an embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact. However, “coupled” may also mean that two or more elements are not in direct contact with each other, but yet still co-operate or interact with each other.

For clarity of explanation, the illustrate embodiments of the present invention is presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

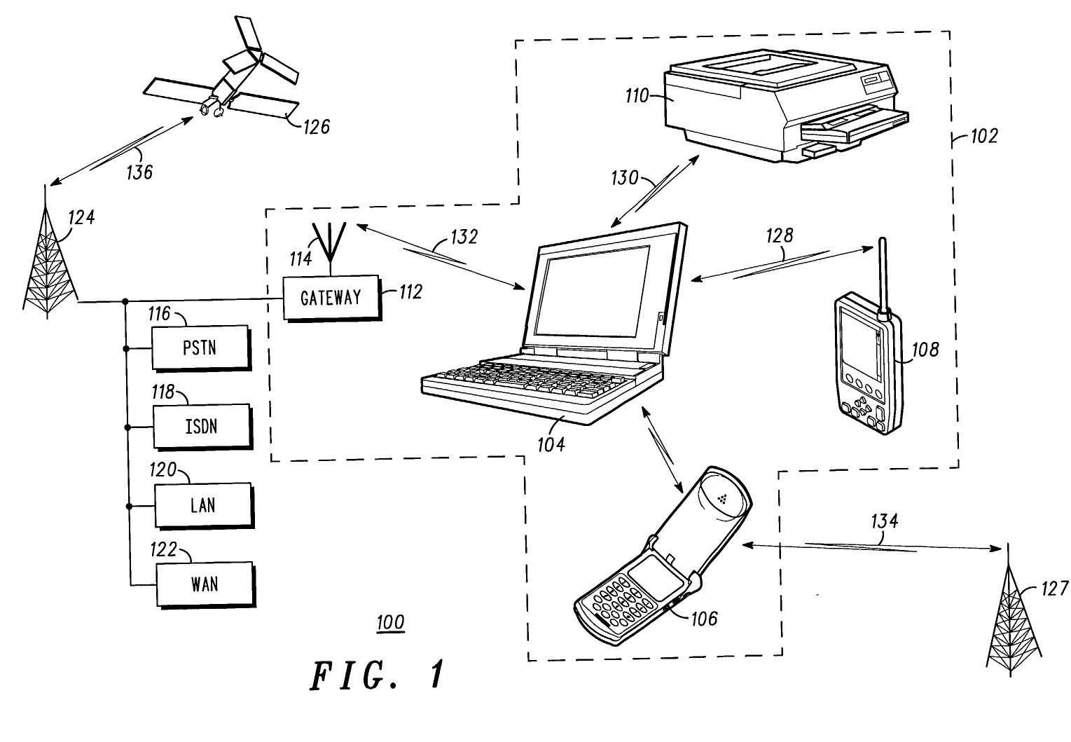

FIG. 1 depicts a communications system 100 according to one embodiment of the invention. As shown in FIG. 1, communications system 100 includes a wireless personal area network (WPAN) 102. WPAN 102 is designed to electronically couple electronic devices in close proximity to one another utilizing only wireless links. Devices in WPAN 102 can also communicate with devices outside of WPAN 102 as illustrated below. As an example of an embodiment, WPAN 102 is designed to electronically couple devices within ten meters of each other. WPAN 102 may include one or more remote devices and one or more client devices. As depicted in FIG. 1, laptop 104 is a remote device, which provides one or more services to client devices. Client devices, which can include a printer 110, Personal Digital Assistant (PDA) 108, wireless or cellular telephone 106, and the like, utilize one or more services provided by remote device. Remote devices and client devices of WPAN 102 communicate utilizing wireless links 128, 130, 132.

WPAN 102 can also be coupled to a wireless cellular network via one or more local nodes 127 and wireless link 134 and can communicate using narrowband and/or broadband connections with standard cellular network protocols such as Global System for Mobile Communications (GSM), Time Division Multiple Access (TDMA), Code Division Multiple Access (CDMA), and the like. In another embodiment, standard transmission control protocol/internet protocol (TCP/IP) can also be used. WPAN 102 may also communicate with a public switched telecommunication network (PSTN) 116, an integrated services digital network (ISDN) 118, local area network (LAN) 120 wide area network (WAN) 122, satellites 126 via relay station 124 wireless link 136, and any number of alternate wireless communication systems through gateway 112 and gateway antenna 114.

The remote devices, client devices and the configuration thereof depicted in FIG. 1 are exemplary and not meant to be limiting of the invention. Other electronic devices can be included in WPAN 102 and other configurations are possible and within the scope of the invention. For example, any electronic device that can be included within WPAN 102 is within the scope of the invention, for example, pages, Web appliances, personal communication systems (PCS), and the like. Also, a client device can also act as a remote device, and a remote device can act as a client device depending on which device is requesting a service and which device is providing a service.

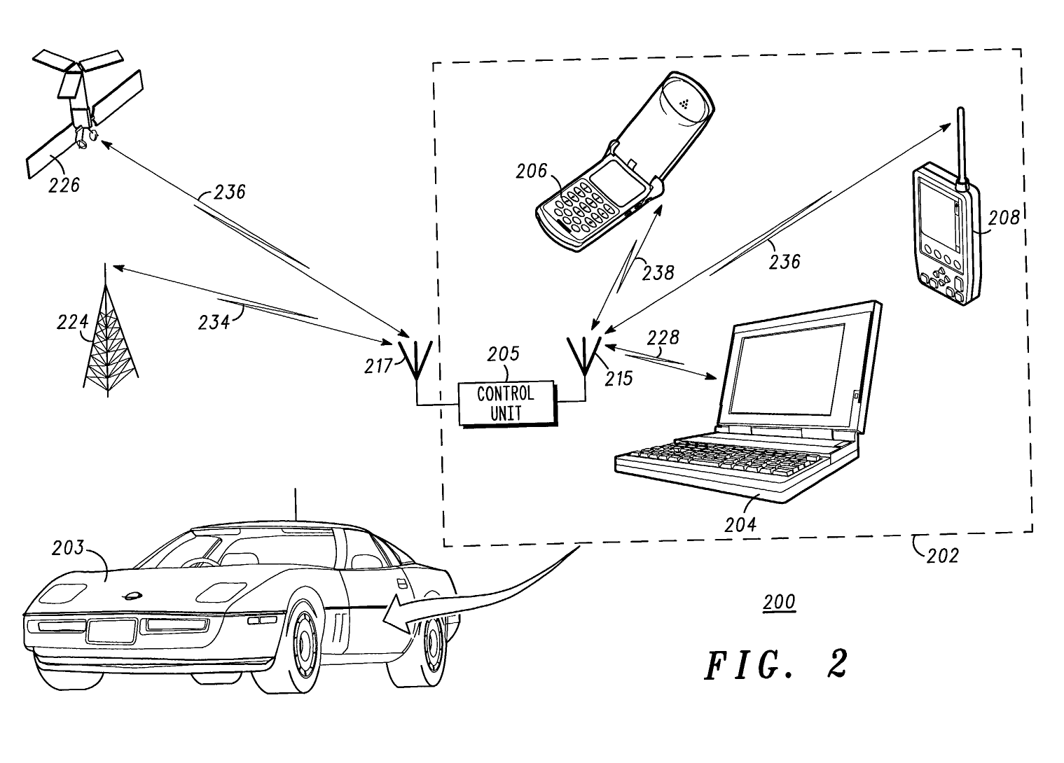

FIG. 2 depicts a communications system 200 according to another embodiment of the invention. As shown in FIG. 2, a WPAN 202 can be contained in, and optionally form an integral part of a vehicle 203, such as a car, truck, bus, train, aircraft, boat, and the like. As an exemplary embodiment, and not meant to be limiting of the invention, vehicle 203 can include a control unit 205, which acts as a remote device and may host one or more services for one or more client devices in WPAN 202. Control unit 205 is coupled to communicate with client devices via antenna 215 and wireless links 228, 236, 238. In the present embodiment, client devices can include, but are not limited to, a laptop computer 204, PDA 208, wireless telephone 206, and the like. Control unit 205 is the service providing entity (remote device), while laptop computer 204, PDA 208, wireless telephone 206, and the like, are service requesting entities (client devices). Together remote device and client devices form a WPAN 202 within and around vehicle 203.

Control unit may also be electronically coupled to other electronic devices and networks via antenna 217 and wireless links 234, 237. For example, control unit 205 can be electronically coupled to satellite 226, wireless cellular network(s) via local node 224, and the like. Services can also be accessed by WPAN 202 via control unit 205 and external networks such a LAN 120, WAN 122, and the like, via control unit 205. Remote devices, client devices and the configuration thereof depicted in FIG. 2 are exemplary and not meant to be limiting of the invention. Other electronic devices can be included in WPAN 102 and other configurations are possible and are within the scope of the invention.

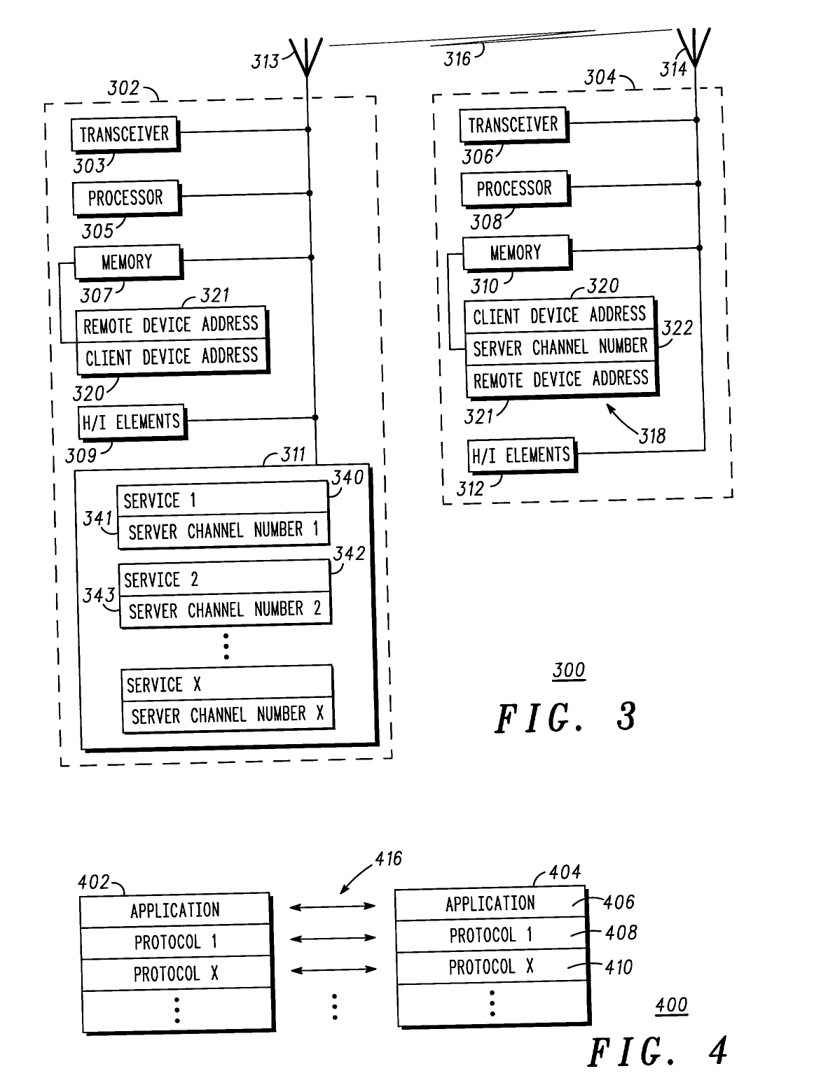

FIG. 3 illustrates a simplified block diagram 300 according to an embodiment of the invention. As shown in FIG. 3, a typical remote device 302 and client device 304 are coupled via wireless link 316. Together, remote device 302 and client device 304 can, along with other remote and client devices, form a WPAN 102, 202. Only one remote device 302 and client device 304 are shown for clarity.

Remote device 302 can include a transceiver 303 designed to communicate with client device 304 through antenna 313. Transceiver 303 is coupled to a processor 305 for processing algorithms stored in memory 307. Memory 307 comprises control algorithms, and can include, but is not limited to, random access memory (RAM), read only memory (ROM), flash memory, electrically erasable programmable ROM (EEPROM), and the like. Memory 307 can contain stored instructions, tables, data, and the like, to be utilized by processor 305. Transceiver 303 can also be coupled to human interface (H/I) elements 309 and services 311. H/I elements 309 are optional and may not be directly included on a remote device 302, for example, a server, and the like.

Human interface (H/I) elements 309 comprise elements such as a display, a multiposition controller, one or more control knobs, one or more indicators such as bulbs or light emitting diodes (LEDs), one or more control buttons, one or more speakers, a microphone, and any other H/I elements required by wireless device. H/I elements 309 can request and display content and data including, application data, position data, personal data, email, audio/video, and the like. The invention is not limited by the (H/I) elements described above. As those skilled in the art will appreciate, the (H/I) elements outlined above are meant to be representative and to not reflect all possible (H/I) elements that may be employed.

Services 311 can be located at remote device 302, distributed between remote device and other remote devices, networks, and the like. A service 311 can be an encapsulation of some functionality that is of use to one or more service-using entities (current or anticipated) or that needs to be isolated from the service-using entity for some reason. A service 311 can provide access to information or perform some computation. Services 311 also provide a desired functionality of a human user, such as applications, an on-board global positioning system (GPS) device, word processor, games, email, and the like. Each of services 311 include a corresponding service channel number, which is a unique identification number assigned to each of services 311. For example, in FIG. 3, service₁ 340 has a corresponding service channel number₁ 341, service₂ 342 has a corresponding service channel number₂ 343 and so forth. Server channel numbers allow client device 304 to access and communicate with each unique service.

Client device 304 can include a transceiver 306 designed to communicate with remote device 302 through antenna 314. Transceiver 306 is coupled to a processor 308 for processing algorithms stored in memory 310. Memory 310 comprises control algorithms, and can include, but is not limited to, random access memory (RAM), read only memory (ROM), flash memory, electrically erasable programmable ROM (EEPROM), and the like. Memory 310 can contain stored instructions, tables, data, and the like, to be utilized by processor 308. Transceiver 306 can also be coupled to human interface (H/I) elements 312. H/I elements 312 are optional and may not be included directly on a client device 304, for example, a server, and the like.

Memory 310 in client device 304 can also contain connection data 318, which may include, but is not limited to, a client device address 320, remote device address 321, a server channel number 322 for each unique service being utilized by client device 304, and the like. Client device address 320 is a unique address assigned to client device 304 so that client device 304 can be uniquely identified on WPAN 102, 202. Remote device address 321 is analogous to client device address 320 for remote device 302. Server channel number 322 is an identification number assigned to each unique service 311 to which client device 304 can access and communicate with. For example, an email application will have a server channel number 322 associated with it on client device 304.

In an embodiment of the invention, connection data 318 is retained by remote device 302 and client device 304 in the event wireless link 316 is terminated. Connection data 318 together includes all necessary parameters relating to a particular communication session between client device 304 and remote device 302 so that in the event wireless link 316 is terminated, as described below, wireless link 316 can be quickly reestablished because necessary parameters relating to a communication session are stored. In other words, when wireless link 316 is reestablished, client device can identify remote device 302 via remote device address 321, remote device 302 can recognize client device 304, via client device address 320, and remote device 302 and client device 304 can both recognize which of one or more services 311 client device 304 was utilizing before termination, via server channel number 322.

FIG. 4 illustrates a simplified block diagram 400 according to an embodiment of the invention. As shown in FIG. 4, remote device 402 and client device 404, to operate together on a WPAN 102, 202, must be interoperable, i.e. operate with identical software protocols and protocol stacks as shown by arrows 416. As mentioned above, services 311 provide functionality, such as applications 406. In order to run an application 406, client device may have to access services 311 provided by an identical application 406 on remote device 402. These identical applications 406 are running over one or more protocols 408, 410. One or more protocols 408, 410 may include “over the air” transport protocols, telephony control protocols, adopted protocols, core protocols, cable replacement protocols, and the like.

There are numerous WPAN systems, each with their own software protocols and protocol stacks to enable remote device 402 and client device 404 to communicate and exchange content, including, voice, data, content, and the like. Examples of these WPAN systems include, but are not limited to, Bluetooth, Infrared Data Association (IrDA), Object Exchange Protocol (OBEX), HomeRF, and the like. In a preferred embodiment of the invention, Bluetooth is utilized. Implementation of the invention in the Bluetooth environment is not limiting of the invention. The invention can be implemented in other WPAN environments and these implementations are also within the scope of the invention.

FIG. 5 illustrates a simplified Bluetooth protocol stack 500 according to an embodiment of the invention. As shown in FIG. 5, a preferred embodiment of a protocol stack is comprised at least partially of Bluetooth specific protocols. Bluetooth protocols are known to one skilled in the art and will only be briefly described here.

Baseband protocol 504 enables a physical Radio Frequency (RF) link between remote device 302, 402 and client device 304, 404 to form a WPAN 102, 202. It provides the functionalities required for remote device 302, 402 and client device 304, 404 to synchronize their clocks and establish wireless link 316. When Bluetooth is used, WPAN 102, 202 can also be known as a Bluetooth wireless network, or a Bluetooth piconet depending on how the various devices are coupled. For example, the differences between a basic WPAN, piconet, scatternet, and the like are known in the art and are within the scope of the invention.

Link Manager Protocol (LMP) 511 is responsible for setting up the wireless link 316 between remote device 302, 402 and client device 304, 404, which includes authentication, encryption, power modes and connection states in WPAN 102, 202. Together, Baseband protocol 504 and LMP 510 comprise the Host Command Interface (HCI) 514, which provides a command interface and access to hardware status and control registers.

Logical Link Control and Adaptation Protocol (L2CAP) 508 allows applications 506 to interact with HCI 514 and provides services to upper protocol layers such as multiplexing, segmentation and reassembly and quality of service features. Service Discovery Protocol (SDP) 512 utilizes remote device 302, 402 and client device 304, 404 information, services 311 and the characteristics of services to be queried to help establish a wireless link 316 between devices.

RFCOMM 510 is a serial emulation protocol, which emulates serial port data signals over Baseband protocol 504, which provides access to L2CAP 508 for applications 506. The protocol stack illustrated in FIG. 5 is exemplary and not limiting of the invention. Other combinations of protocols may be used to form a protocol stack and are within the scope of the invention.

Software blocks that perform embodiments of the invention are part of computer program modules comprising computer instructions, such as control algorithms, that are stored in a computer-readable medium such as memory described above. Computer instructions can instruct processors to perform methods for wireless link reestablishment. In other embodiments, additional modules could be provided as needed.

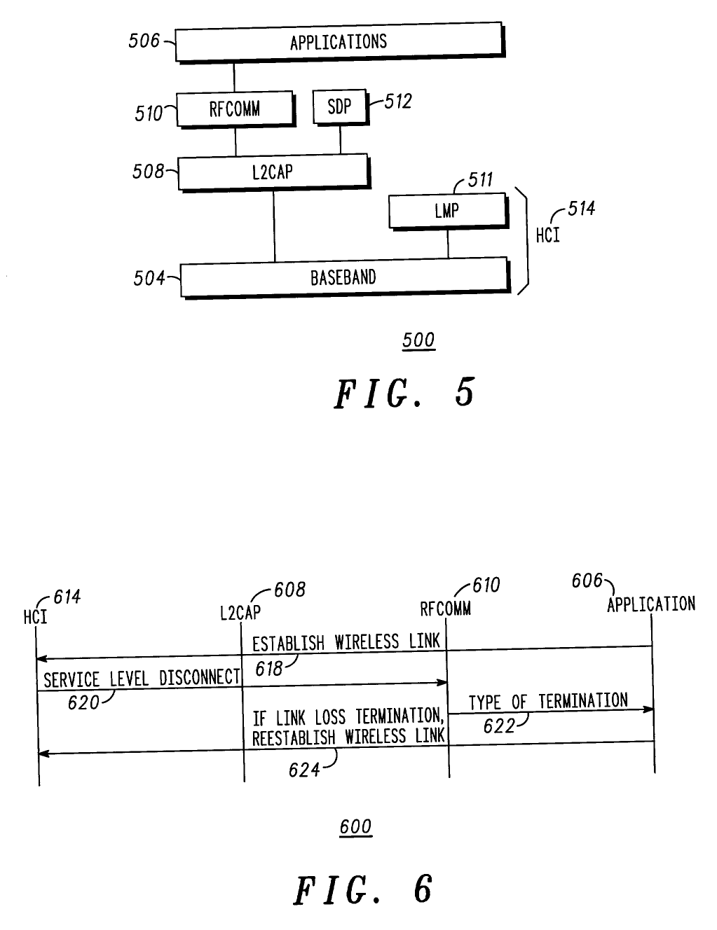

FIG. 6 illustrates a simplified message sequence chart 600 according to an embodiment of the invention. The protocols shown in FIG. 6 are specific to an embodiment of the invention using Bluetooth. However, the invention is not limited to the use of Bluetooth or the protocol stack shown and encompasses the use of any other WPAN 102, 202 protocols, services, and the like. As shown in FIG. 6, an application 606 in client device 304, 404 sends an establish wireless link signal 618 in order to establish a wireless link 316 with a remote device 302, 402 in order to access a service or application on remote device 302, 402. Signal 618 filters down through the protocol stack to the HCI layer 614 where wireless link 316 is then established with remote device 302, 402. In FIG. 6, application may be requesting services 311, accessing data, and the like from remote device 302, 402. Subsequently, there is a service level disconnect 620, where wireless link 316 is terminated, thereby disconnecting remote device 302, 402 and client device 304, 404. A service level disconnect 620 occurs when wireless link 316 is terminated and client device 304, 404 can no longer access services 311 at remote device 302, 402. Service level disconnect signal 620 is communicated to RFCOMM protocol in both client device 304, 404 and remote device 302, 402.

In an embodiment of the invention, a protocol, for example, RFCOMM 610, determines the type of termination 622 of wireless link 316 and communicates this to application 606. RFCOMM 610 determines the type of termination 622 by differentiating between a link loss termination and a non-link loss termination. In a non-link loss termination, generally a termination of wireless link 316 is initiated at either the remote device 302, 402 end or the client device 304, 404 end. In a link loss termination, wireless link 316 is lost due to, among other things, interference, moving out of range, and the like. A link loss termination is generally not initiated by either remote device 302, 402 or client device 304, 404. In another embodiment of the invention, the type of termination 622 occurs in the L2CAP protocol 608. Analogously, type of termination 622 can also be classified as intentional and non-intentional link termination.

After RFCOMM communicates the type of termination 622, application then decides if client device 304, 404 will attempt to reestablish wireless link 316 with remote device 302, 402. In an embodiment of the invention, if client device 304, 404 determines the type of termination 622 is a link loss termination, client device 304, 404 attempts to reestablish wireless link 624 to remote device 302, 402 utilizing connection data 318. The use of connection data 318 ensures that client device 304, 404 can reestablish wireless link 316 promptly because new connection data does not have to be generated. For example, client device address 320 ensures remote device 302, 402 knows which client device 304, 404 it was communicating with, and server channel number 322 ensures that both remote device 302, 402 and client device 304, 404 know which services were being utilized before service level disconnect 620. In an embodiment of the invention, client device 304, 404 may continue to attempt to reestablish wireless link 316 up to a maximum number of attempts or until a timeout is reached via a timer.

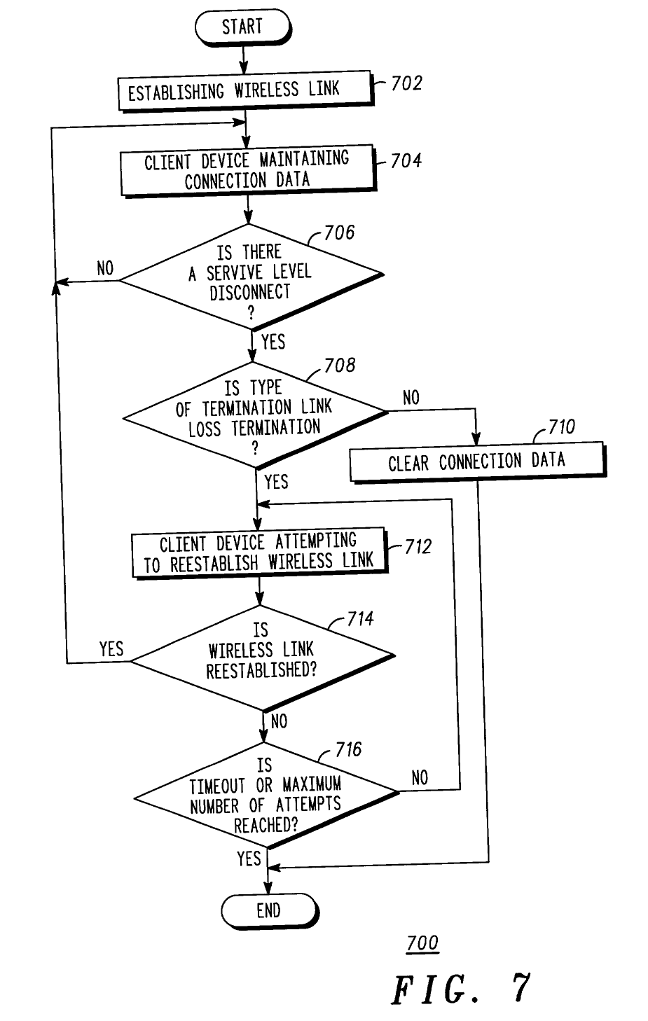

FIG. 7 illustrates a flow diagram 700 of a method of the invention according an embodiment of the invention. In step 702, wireless link 316 is established between a remote device 302, 402 and a client device 304, 404 in a WPAN 102, 202. In a preferred embodiment of the invention, WPAN 102, 202 can be a Bluetooth wireless network or a Bluetooth piconet.

In step 704, client device 304, 404 maintains connection data 318 from a communication session with remote device 302, 402. Maintaining connection data 318 can include storing connection data 318 and updating connection data 318 as required during a communications session. Connection data 318 maintained in client device 304, 404 can include, but is not limited to, client device address 320, remote device address 321, server channel number 322 for each unique service accessed from remote device 302, 402, and the like. In another embodiment of the invention, remote device 302, 402 also maintains connection data 318.

In step 706, it is determined if there is a service level disconnect. If there is no service level disconnect, client device continues to maintain connection data per step 704. If there is a service level disconnect, it means wireless link 316 is terminated. In step 708 the type of termination is determined. In an embodiment of the invention, the determination of the type of termination occurs in one of the protocols of client device 304, 404 protocol stack. The type of termination is then communicated to applications 406, 506 on client device 304, 404 that are utilizing services 311 on remote device 302, 402. In an embodiment of the invention, the type of link loss determination occurs in the L2CAP protocol 508. In a particularly preferred embodiment of the invention, the type of link loss determination occurs in the RFCOMM protocol 510.

If the type of termination is not a link loss termination, it generally means either the remote device 302, 402 or client device 304, 404 end terminated wireless link 316 and connection data 318 is cleared per step 710. If it is determined the type of termination is a link loss termination, client device 304, 404 attempts to reestablish wireless link 316 per step 712. In an embodiment of the invention, application 406, 506 determines if it wants to reestablish wireless link 316 if the type of termination is link loss termination. Wireless link 316 is reestablished utilizing connection data 318 so that an entirely new communication session is not required. In effect, wireless link reestablishment is transparent to a user of client device 304, 404 since the communication session picks up where it left off due to the maintaining of connection data 318.

In step 714, it is determined if wireless link is reestablished. If so, client device 304, 404 continues to maintain connection data 318 per step 704. If wireless link 316 is not reestablished, it is determined if timeout has been reached or maximum number of attempts has been reached per step 716. If either of these conditions is met, no further attempts are made to reestablish wireless link 316. If neither of these conditions is met, client device continues attempts to reestablish wireless link 316 per step 712.

The method of the invention offers numerous advantages in that quick and automatic reestablishment of a wireless link is achieved between two devices in WPAN environment is achieved. This eliminates the user having to manually reestablish a wireless link in the event of inadvertent link termination. Also, wireless link is reestablished using existing connection data so that the communication session can begin where it left off and any interruption and reestablishment is transparent to the user. This has the advantage of providing the user with a more pleasant WPAN experience and avoids loss of data and time in having to reestablish a wireless link when the link is inadvertently lost during a communication session.

While we have shown and described specific embodiments of the present invention, further modifications and improvements will occur to those skilled in the art. It is therefore, to be understood that appended claims are intended to cover all such modifications and changes as fall within the true spirit and scope of the invention.

1. In a wireless personal area network, a method of wireless link reestablishment between a remote device and a client device, comprising:
establishing a wireless link between the remote device and the client device, wherein the client device maintains connection data;
terminating the wireless link;
the client device determining a type of termination by differentiating between a link loss termination and a non-link loss termination; and
if the client device determines the type of termination is the link loss termination, the client device reestablishing the wireless link to the remote device utilizing the connection data.

2. The method of claim 1, wherein the client device comprises an application and at least one protocol, wherein determining the type of termination occurs in the at least one protocol, and wherein the type of termination is communicated to the application.

3. The method of claim 2, wherein the client device reestablishing the wireless link comprises the application determining to reestablish the wireless link.

4. The method of claim 2, wherein the wireless personal area network is a Bluetooth wireless network.

5. The method of claim 4, wherein the at least one protocol is a L2CAP protocol.

6. The method of claim 4, wherein the at least one protocol is an RFCOMM protocol.

7. The method of claim 1, wherein the connection data comprises a remote device address.

8. The method of claim 1, wherein the connection data comprises a server channel number.

9. In a client device, a method of wireless link reestablishment within a wireless personal area network, comprising:
establishing a wireless link between a remote device and the client device, wherein the client device maintains connection data, and wherein the wireless link is subsequently terminated;
determining a type of termination by differentiating between a link loss termination and a non-link loss termination; and
if the type of termination is the link loss termination, the client device reestablishing the wireless link to the remote device utilizing the connection data.

10. The method of claim 9, wherein the client device comprises an application and at least one protocol, wherein determining the type of termination occurs in the at least one protocol, and wherein the type of termination is communicated to the application.

11. The method of claim 10, wherein the client device reestablishing the wireless link comprises the application determining to reestablish the wireless link.

12. The method of claim 10, wherein the wireless personal area network is a Bluetooth wireless network.

13. The method of claim 12, wherein the at least one protocol is a L2CAP protocol.

14. The method of claim 12, wherein the at least one protocol is an RFCOMM protocol.

15. The method of claim 9, wherein the connection data comprises a remote device address.

16. The method of claim 9, wherein the connection data comprises a server channel number.

17. In a Bluetooth piconet, a method of wireless link reestablishment between a remote device and a client device, comprising:
establishing a wireless link between the remote device and the client device, wherein the client device maintains connection data;
terminating the wireless link;
the client device determining a type of termination by differentiating between a link loss termination and a non-link loss termination; and
if the client device determines the type of termination is the link loss termination, the client device reestablishing the wireless link to the remote device utilizing the connection data.

18. The method of claim 17, wherein the client device comprises an application and at least one protocol, wherein determining the type of termination occurs in the at least one protocol, and wherein the type of termination is communicated to the application.

19. The method of claim 18, wherein the client device reestablishing the wireless link comprises the application determining to reestablish the wireless link.

20. The method of claim 18, wherein the at least one protocol is a L2CAP protocol.

21. The method of claim 18, wherein the at least one protocol is an RFCOMM protocol.

22. A computer-readable medium containing computer instructions for instructing a processor to perform in a client device, a method of wireless link reestablishment within a wireless personal area network, the instructions comprising:
establishing a wireless link between a remote device and the client device, wherein the client device maintains connection data, and wherein the wireless link is subsequently terminated;
determining a type of termination by differentiating between a link loss termination and a non-link loss termination; and
if the type of termination is the link loss termination, the client device reestablishing the wireless link to the remote device utilizing the connection data.

23. The computer-readable medium of claim 22, wherein the client device comprises an application and at least one protocol, wherein determining the type of termination occurs in the at least one protocol, and wherein the type of termination is communicated to the application.

24. The computer-readable medium of claim 23, wherein the client device reestablishing the wireless link comprises the application determining to reestablish the wireless link.

25. The computer-readable medium of claim 23, wherein the wireless personal area network is a Bluetooth wireless network.

26. The method of claim 25, wherein the at least one protocol is a L2CAP protocol.

27. The method of claim 25, wherein the at least one protocol is an RFCOMM protocol.

28. The method of claim 22, wherein the connection data comprises a remote device address.

29. The method of claim 22, wherein the connection data comprises a server channel number.
